(19) United States
(12) Patent Application Publication
(10) Pub. No.: US 2009/0295142 A1
(43) Pub. Date: Dec. 3, 2009

(54) REPOSITIONABLE LABEL AND RELATED METHOD

(76) Inventors: Alan William Maule, Brea, CA (US); Thomas Mammen, La Verne, CA (US); Michelle Ann Canellopoulos, Chino Hills, CA (US); Uyen Vu Phuong Tran, Laguna Beach, CA (US); Galen Chia Lin Wong, South Pasadena, CA (US); Gregory Allen Bodager, Madison, OH (US); Kenneth John Wolfe, Altoona, PA (US); James Probst Akeley, Mill Hall, PA (US)

Correspondence Address: AVERY DENNISON CORPORATION;Patent Group, Law Department - 3 South, P.O. BOX 7090, PASADENA, CA, 91109-7090, US

(21) Appl. No.: 12/131,633

(22) Filed: Jun. 2, 2008

(51) Int. Cl. B42D 15/00; B44C 1/16

(52) U.S. Cl. 283/81; 156/237

(57) ABSTRACT

A label that includes an adhesive and is configured to be applied to an item, and related method. The adhesive is characterized as having a permanence that starts to develop upon contact of the label with the item and builds over time so eventually the label is permanently coupled to the item. The item can be damaged as a result of the label being removed from the item after the label is permanently coupled to the item. If the label is applied to the item in a first position, then the adhesive is configured to allow a removal of the label from the item without damaging the items and a reapplication of the label to the item in a second position within a limited period of time.

### FIELD OF THE INVENTION

The present invention generally relates to labels. More specifically, the present invention relates to repositionable labels and a related method of manufacture.

### BACKGROUND

There are many types of labels, for example, labels that are used to identify objects, e.g., commercial products and personal items, and labels are used to identify the sender or the recipient of mailed envelopes and packages. Most labels include a face stock, upon which identification information is printed or written, and a layer of adhesive that is coupled to the face stock. In some instances, the label's adhesive is configured to bond the label immediately and permanently to the surface of the item to which the label is applied. Because of the immediate and permanent bonding of the label to the surface, the label and/or the surface to which the label has been applied will be damaged, e.g., torn, if the label is removed from the surface. Even though there is a potential for damage to the label and/or the underlying surface, subsequent removal of the label from the surface may be required if any one of the following occurs: the label includes a typographical error, the label is applied to the wrong surface, or item the label is positioned incorrectly, e.g., crooked, upside down, etc., on the surface.

In addition to the potential for damaging the label or the surface to which the label is applied, the label can curl, wrinkle, or bubble after removal from the surface. If an attempt is made to reapply the label to the same or another surface, the reapplied label can have an unprofessional appearance due to the damage, e.g., the tearing, curling, wrinkling, and/or bubbling, that resulted from the removal of the label from the surface. Also, a reapplied label may not permanently adhere to the surface, i.e., the reapplied label may have a higher likelihood of separating from the item. This inability to adhere may result from the adhesive, before reapplication, being covered with parts, e.g., fibers, of the surface that were removed when the label was pulled from the surface.

In other situations, the label's adhesive is configured to bond the label only temporarily to a surface. In these cases, the label never develops a permanent bond with the underlying surface, and thus, is of limited practical use. Such a label that develops only a temporary bond with a surface is not configured to provide a user with evidence of tampering if the label is removed from the surface.

Accordingly, existing labels either form a permanent and immediate bond with many common surfaces to which the label may be applied, or never form a permanent bond with the surface. It should, therefore, be appreciated that there is a need for a repositionable label that can be cleanly removed from one substrate and then reapplied to form a permanent bond with many common surfaces to which it is reapplied. The present invention satisfies this need.

### SUMMARY

The present invention includes a label that is configured to be applied to a surface and to develop a permanent bond with the surface after a period of time within which the label can be repositioned without damaging the label or the surface. An exemplary embodiment is a label that includes an adhesive and is configured to be applied to an item. The adhesive is characterized as having a permanence that starts to develop upon contact of the label with the item and builds over time so eventually the label is permanently coupled to the item. The item can be damaged as a result of the label being removed from the item after the label is permanently coupled to the item. If the label is applied to the item in a first position, then the adhesive is configured to allow the removal of the label from the item without damaging the items and the reapplication of the label to the item in a second position within a limited period of time.

In other, more detailed features of the invention, the limited period of time is less than or equal to approximately five minutes. Also, the limited period of time can be less than or equal to approximately one minute. A suitable adhesive can be AT-1.

In other, more detailed features of the invention, the adhesive is configured into a layer of adhesive. The layer of adhesive can have a thickness from approximately 10.2 micrometers to approximately 15.2 micrometers. The layer of adhesive can have a coat weight from approximately 13 grams per square meter to approximately 19 grams per square meter. In particular, the layer of adhesive can have a coat weight from approximately 15 grams per square meter to approximately 17 grams per square meter.

In other, more detailed features of the invention, the label further includes a layer of face stock that is coupled to the layer of adhesive. The label can be configured so information can be printed on the layer of face stock using a laser printer, an inkjet printer, or a networked photocopier. Also, the label can be configured to be coupled to a liner before the label is applied to the items and when the label is coupled to the liner, a layer of release agent is coupled between the adhesive and the liner.

In other, more detailed features of the invention, the item is an envelope, a postcard, a business card, a mailing tube, a piece of cardboard, a piece of paper, a box, a file folder, a binder, a notebook cover, a container, or a piece of foam display board.

Another exemplary embodiment is a label that is configured to be applied to an items where the label includes an adhesive. The adhesive is configured to do the following if the label is applied to the item: to allow the removal of the label from the item within a period of time, and to eventually couple the label permanently to the item. The item can be damaged as a result of the label being removed from the item after the label is permanently coupled to the item.

In other, more detailed features of the invention, the adhesive is configured to permanently couple the label to the item within 20 minutes after the label is applied to the item. Also, the adhesive can be configured to allow for the removal of the label from the item within the period of time without damaging the label or the item.

An exemplary method according to the invention is a method for manufacturing a label that is configured to be applied to an item. The method includes providing a layer of face stock having a surface, providing an adhesive, and coupling the adhesive to the surface of the layer of face stock. The adhesive is configured to do the following after the label is applied to the item: to allow for a removal of the label from the item within a period of time, and to eventually couple the label permanently to the item. The item can be damaged as a result of the label being removed from the item after the label is permanently coupled to the item.

In other, more detailed features of the invention, the step of coupling the adhesive to the surface of the face stock includes coating the adhesive on the surface of the layer of face stock. Also, the step of coupling the adhesive to the layer of face stock can include forming the adhesive into a layer of adhesive.

Other features of the invention should become apparent to those skilled in the art from the following description of the preferred embodiments taken in conjunction with the accompanying drawings, which illustrate, by way of example, the principles of the invention, the invention not being limited to any particular preferred embodiment(s) disclosed.

### BRIEF DESCRIPTION OF THE DRAWINGS

These and other features, aspects, and advantages of the present invention will become better understood with reference to the following description, appended claims, and accompanying drawings, where:

FIG. 1 is top plan view of a repositionable label according to a preferred embodiment.

FIG. 2 is a sectional view of the repositionable label taken along line 2-2 of FIG. 1.

FIG. 3 is a sectional view of a repositionable label that is coupled to a combination of a liner and a layer of release agent according to a preferred embodiment.

FIG. 4 is a side elevational view of the repositionable label of FIGS. 1-3 being applied to, or removed from, a surface.

FIG. 5 is a side elevational view of the repositionable label of FIGS. 1-4 applied to a surface.

FIG. 6 is a top plan view of a repositionable label including printed information according to a preferred embodiment.

FIG. 7 is a block diagram showing a process of printing information onto a label.

FIG. 8A is a top plan view of a repositionable label according to a preferred embodiment coupled to an item in an undesirable first position.

FIG. 8B is a top plan view of the repositionable label of FIG. 8A repositioned in a more desirable second position.

FIG. 9 is a block diagram showing a face stock and an adhesive being input to a coating process which results in a repositionable label according to a preferred embodiment.

FIG. 10 is a flowchart of an example method for manufacturing a label according to the invention.

Unless otherwise indicated, the illustrations in the above figures are not necessarily drawn to scale.

### DETAILED DESCRIPTION

Most users realize within approximately five minutes, and in many instances within approximately one minutes of the application of a label to an item whether the label needs to be repositioned. Embodiments of the present invention are configured to allow a user to reposition a label after application of the label to the surface of an item for up to approximately five minutes without damaging the label or the surface. These repositionable labels can be used on the surface of any items for example, a mailing envelope, a postcard, a business card, a mailing tube, a piece of cardboard, a piece of paper, a box, a file folder, a binder, a notebook cover, a compact disc (“CD”), a digital video disc (“DVD”), a magnetic or optical recording diskette, a container, a piece of stainless steel, a piece of painted stainless steel, a piece of glass, a piece of aluminum, a piece of plastic, or a piece of foam display board.

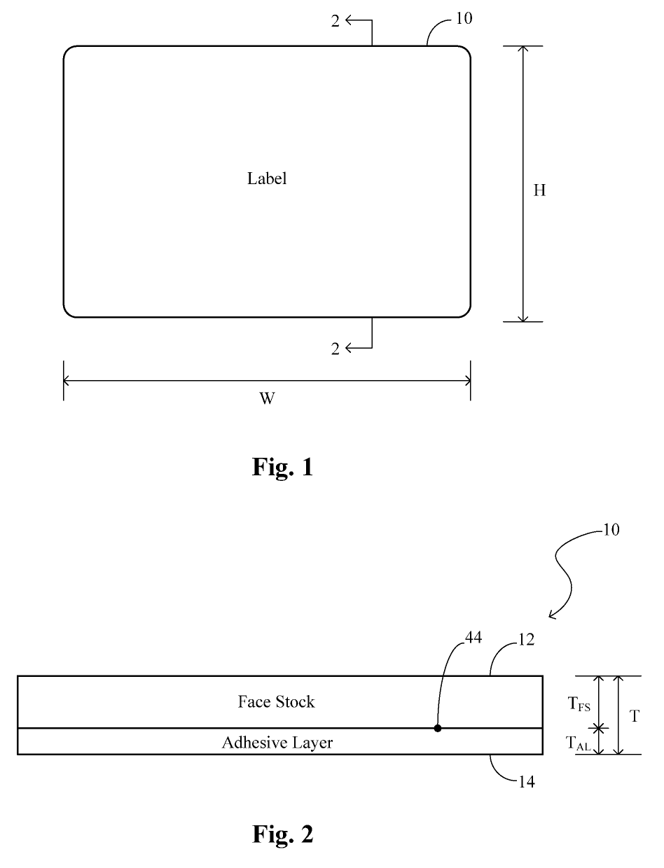

Referring to FIGS. 1 and 2, the present invention is embodied in a repositionable label 10 that includes a layer of face stock 12 and an underlying layer of adhesive 14. The top plan view of an example embodiment of the label is shown in FIG. 1. The width “W” and height “H” of the label can vary in value, for example, the width “W” can range in value from approximately 4.44 centimeters to approximately 27.94 centimeters, and the height “H” can range in value from approximately 1.27 centimeters to approximately 21.59 centimeters.

As shown in the sectional view shown in FIG. 2, which is taken along line 2-2 of FIG. 1, the thickness of each of the label's layers 12 and 14 can range in value. In example embodiments, the thickness of the face stock “T_{FS}” can range from approximately 38.1 micrometers to approximately 101.6 centimeters, and the thickness of the adhesive layer “T_{AL}” can range from approximately 10.2 micrometers to approximately 15.2 micrometers. Accordingly, the thickness of the label 10, which includes the thickness of the face stock “T_{FS}” and the thickness of the adhesive layer “T_{AL},” can range from approximately 48.3 micrometers to approximately 116.8 micrometers.

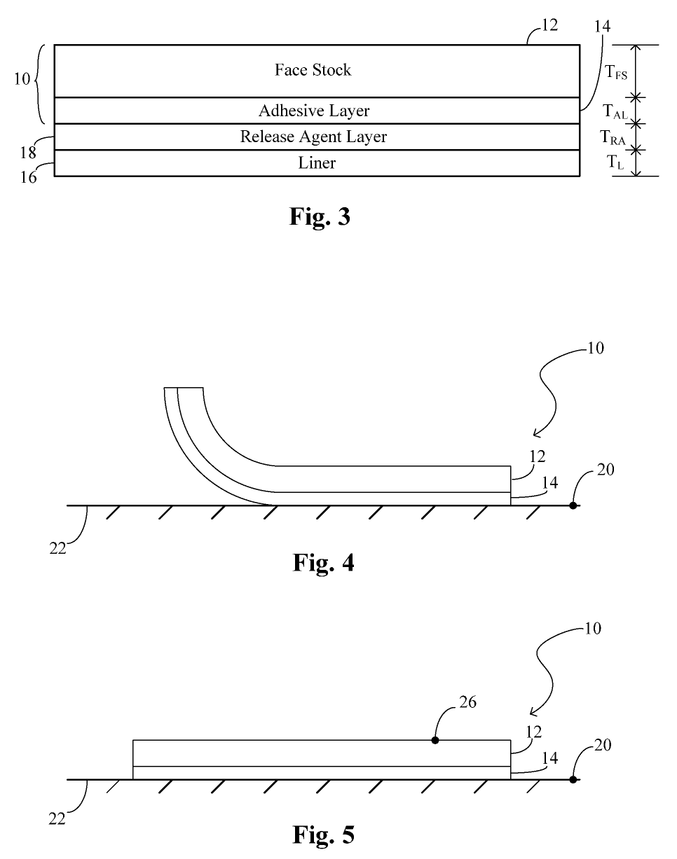

Initially, as shown in the sectional view shown in FIG. 3, the label 10 is coupled to a liner 16 that, for example, can be made of paper or polyester, via a layer of release agent 18 that is made of a release material, for example, silicone. In the example embodiment shown in FIG. 3, the liner has a thickness “T_{L}” that can range in value from approximately 38.1 micrometers to approximately 101.6 micrometers, and the layer of release agent has a thickness “T_{RA}” that can range in value from approximately 1.0 micrometers to approximately 1.5 micrometers.

During use, a user separates the label 10 from the liner 16, and in the process, decouples the adhesive layer 14 from the layer of release agent 18. Next, the user applies the label to the surface 20 of an item 22, and in doing so, couples the face stock 12 to the surface via the adhesive layer, as shown in FIG. 4, which depicts the label as it is being applied to, or removed from, an underlying surface. FIG. 5 shows the label after it has been applied completely to the underlying surface. As time passes, and the label remains in contact with the surface, the adhesion (gm/centimeter) for the adhesive increases in value, and eventually the bond facilitated by the adhesive between the label and the surface becomes permanent after approximately 20 minutes. The adhesion characteristic of the label is also referred to as “permanence”. A permanent bond is formed between the label and the underlying surface of a substrate when the adhesive bond strength is greater than the internal bond strength of either the face stock or the substrate. An increasing value of permanence, i.e., providing an increasingly long-lasting bond between the label and the items means that that the value of adhesion that is associated with the adhesive is also increasing. Accordingly, the adhesive is characterized as having a permanence that starts to develop upon contact of the label with the underlying surface, and builds over time so eventually the label is permanently bonded (also referred to as “coupled”) to the underlying surface of the item. Also, depending upon the items and the material that is used to make the items the item can be damaged as a result of the label being removed from the item after the label is permanently coupled to the item.

While the example label 10 shown in FIG. 1, is generally rectangular in shape, the shape of other embodiments of the label can be any shape, for example, square, round, elliptical, or labels that are specially cut, for example, by die cutting, with individually, unique, and varied designs. Also, while the example label, as shown in FIG. 2, includes two layers, i.e., a face stock layer 12 and a layer of adhesive 14, individuals having ordinary skill in the art should know that the label can include additional layers, e.g., a high-opacity coating, or other functional layers that can provide moisture resistance, air resistance, or security features between the face stock layer and the adhesive layer.

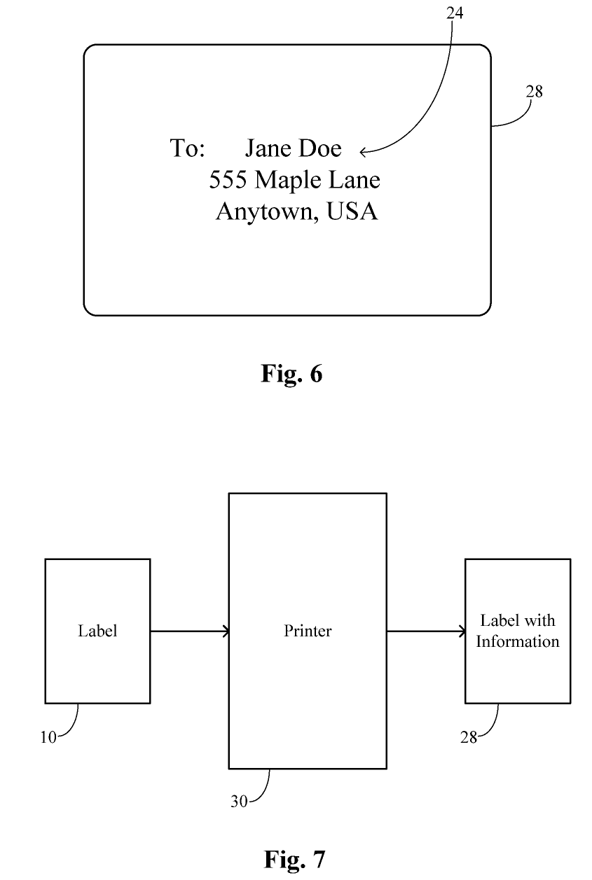

Referring additionally to FIGS. 6 and 7, embodiments of the repositionable label 10 are configured for desktop printing. Accordingly, the information 24 that is included on the top surface 26 of the printed label 28 can be deposited/printed on the label using a desktop printer 30, e.g., a laser printer, an ink jet printer, or a networked photocopier.

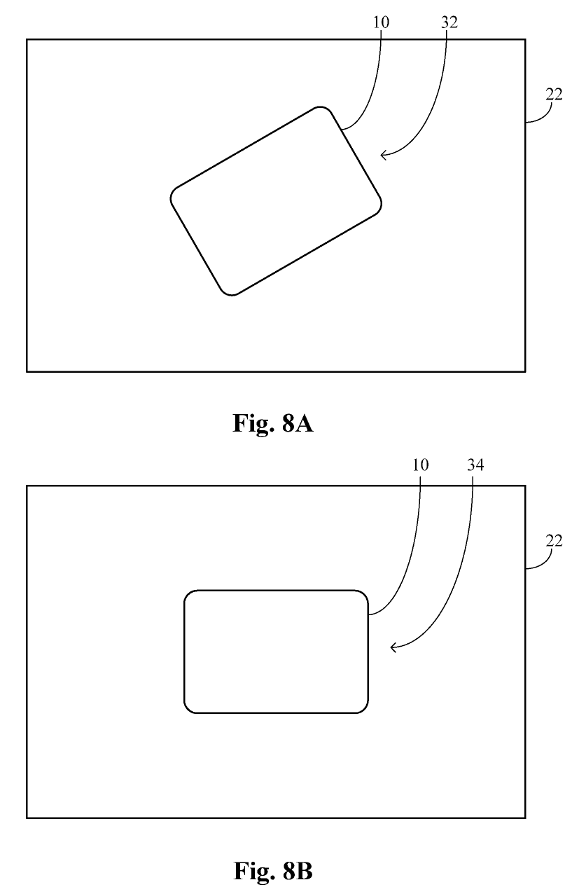

Overall, embodiments of the repositionable label 10 allow users to format, print, peel, and apply the repositionable label to an item 22 as they would any other label. However, embodiments of the repositionable label are configured to allow a user to remove the repositionable label after application, and to reapply it if the need arises. Referring additionally to FIGS. 8A and 8B, an example repositionable label is shown prior to, and after, reposition. More specifically, FIG. 8A is a top plan view of a label that has been coupled to the surface 20 of an envelope 22 in a first position 32, which is crooked and undesirable. After a user removes the incorrectly positioned label, the user reapplies it to the envelope in a second position 34 shown in FIG. 8B, which is more desirable.

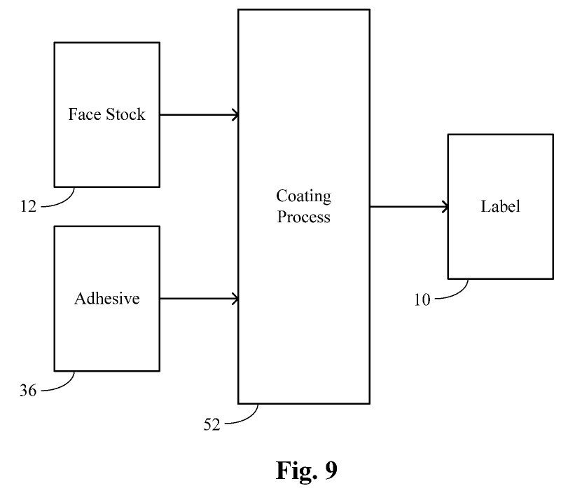

Referring additionally to FIG. 9, while various factors influence the ability of the embodiment labels 10 to be removed from a surface 20 after application including, for example, characteristics of the face stock 12, e.g., the thickness, the stiffness, and the internal bond strength of the face stock, and characteristics of the surface, the primary factor that influences the ability of the labels to be repositionable are the characteristics of the adhesive 36 that is used in the adhesive layer 14.

The adhesive 36 used in embodiments of the repositionable labels 10 can be made from, for example, AT-1, which is a commercial emulsion acrylic pressure-sensitive adhesive made by Avery Dennison Corporation of Pasadena, Calif. AT-1 has a glass transition temperature (“T_{g}”) value of approximately −48° C. to approximately −55° C., so peak adhesion occurs at a temperature below ambient temperature. AT-1 has a relatively high molecular weight without a lot of branching, so the adhesive has a smooth texture, and an emulsion particle size greater than one micron, so there is less contact between the AT-1 emulsion particles and the surface than other typically high permanence adhesives. The particles of the AT-1 emulsion are believed to have little initial hydrogen bonding with the surface—further resulting in weak adhesion (at least when contact is first made between the label and the surface). As the time of contact increases, the hydrogen bonds increase through increases in surface area and hydrogen bond development.

The label's adhesive 36 provides for short-term repositionability because, as embodied in the invention, the permanence of the adhesive builds over time, which allows a period of time for the label to be repositioned. In particular, within approximately five minutes, and in some embodiments within approximately one minute, of application of the repositionable label 10 to a surface 20, the label can be removed from the surface without damaging the label or the surface, and then reapplied to that surface or another surface. After the approximately five minute length of time, or the approximately one minute period of time, the repositionable label will stick and stay bonded to many common items 22, for example, white, brown, manila, colored, recycled, padded, and/or bubble envelopes, corrugated cardboard, mailing tubes, TYVEK® offered by the DuPont Company of Wilmington Del., high-density polyethylene, copy paper, magazine paper, postcards, business cards, photo paper, glossy cards, aluminum, glass, painted steel, stainless steel, acrylonitrile butadiene styrene (“ABS”), polycarbonate, polyester, polypropylene, vinyl, manila and plastic file folders, compact discs, computer disks, and/or foam display boards.

Experimental testing of embodiments of the repositionable label 10 that include AT-1 as the adhesive 36 has shown that if the label is removed from the surface 20 of a mailing envelope 22 within approximately two minutes of initial application, that no fibers are removed from the envelope's surface and the surface did not tear. After approximately two minutes, the permanence of the adhesive's bond to the envelope increased quickly after reapplication of the label to the envelope resulting in noticeable removal of fibers from the envelope when attempts were made to remove the reapplied label from the envelope after fifteen minutes. Accordingly, in example embodiments, the repositionable label can be removed from an envelope after approximately two minutes without damaging the envelope's surface, and then reapplied to the envelope's surface resulting in the label forming a permanent bond with the envelope's surface within approximately fifteen minutes.

In example embodiments, the adhesive layer 14 has a coat weight in a range from approximately 13 grams per square meter (“gsm”) to approximately 19 gsm, i.e., approximately 16 gsm+/−3 gsm. Within the coat weight range from approximately 13 gsm to approximately 19 gsm, the labels 10 offered repositionability and long-term permanence. In particular, embodiments of the label having a coat weighting of 15 gsm offered acceptable repositionability for up to approximately five minutes. In other embodiments, where the coat weight of the adhesive layer was 18 gsm, the adhesive provided greater adhesion while still allowing for the label to be repositionable for up to approximately three minutes. In other embodiments, the adhesive layer coat weight ranged from approximately 15 gsm to approximately 17 gsm, i.e., approximately 16 gsm+/−1 gsm.

As previously mentioned, the ability of the label 10 to be removed and repositioned on the surface 20 of an item 22, in addition to being dependent upon the characteristics of the adhesive 36, are also dependent upon the characteristics of the surface to which the label is bonded. For example, the length of time that the repositionable label has before removing it from the surface will result in damage to the surface, e.g., fiber picking, tearing, or adversely effecting, will be less if the surface material is characterized as being more porous or less smooth, e.g., a padded envelope that has a soft, porous surface material. Also, the ability of the label to develop a permanent bond to an underlying surface is also dependent upon the characteristics of the surface material. For example, low surface energy surfaces, e.g., high-density polyethylene (“HDPE”) and plastics, are more difficult to which to bond. Accordingly, the nature of the material that makes up the item's surface affects the length of time that the label is repositionable without damaging the label or items and the length of time it takes for the label to develop a permanent bond with the item.

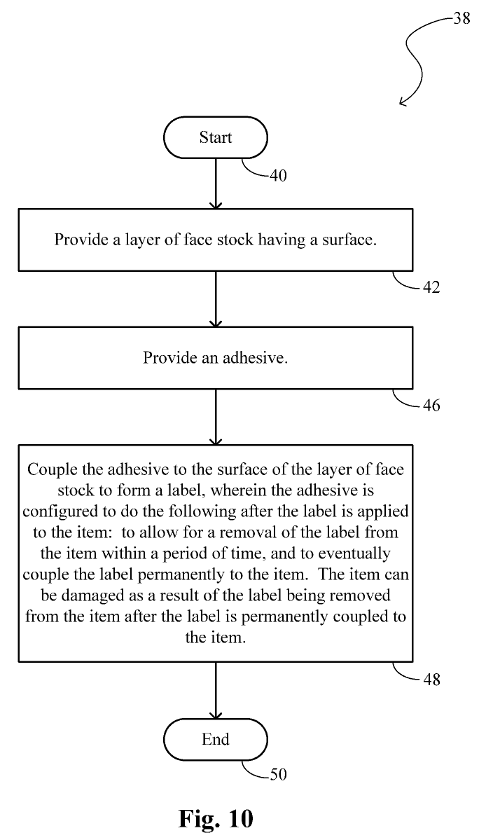

Referring additionally to FIG. 10, an exemplary method for manufacturing a repositionable label 10 that is configured to be applied to an item 22 according to the present invention is illustrated in algorithm 38. After starting the method at step 40, the next step 42 is to provide a layer of face stock 12 that has a surface 44. Next, at step 46, an adhesive 36 is provided. Next, at step 48, the adhesive is coupled to the surface of the face stock. The adhesive is configured to do the following after the label is applied to the item: to allow for a removal of the label from the item within a period of time, and to eventually couple the label permanently to the item. The item can be damaged as a result of the label being removed from the item after the label is permanently coupled to the item. The method ends at step 50. After these steps, the label can be coupled to a liner 16 that is coated with a release agent 18.

The step 48 of coupling the adhesive 36 to the surface 44 of the face stock 12 can include a process 52 of coating the adhesive on the surface of the face stock. The process used for coating the adhesive on the surface of the face stock can be any of a variety of coating processes, e.g., a slot die coating process or curtain coating process. Also, the step of coupling the adhesive to the layer of face stock can include forming the adhesive into a layer of adhesive 14.

Advantageously, embodiment labels 10 of the present invention allow time for a user to move or reposition a label after it initially is applied to a surface 20. The repositionable labels allow users to correct for alignment mistakes. Because repositionable labels can be removed and reapplied, the work, time, and money associated with reprinting individual labels is saved. Many users print labels hundreds or thousands at a time, thus, recreating and reprinting labels can take a significant amount of time and effort, and waste a significant amount of money. Also, embodiments of the present invention allow for labels that are printed with typographical errors be removed from an item without damaging the surface of the item 22. A replacement label without the typographical error can be created and put on the same item in place of the prior label.

All of the features disclosed in the specification, including the claims, abstract, and drawings, and all of the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

We claim:

1. A label that is configured to be applied to an items the label comprising:
a. an adhesive that is characterized as having a permanence that starts to develop upon contact of the label with the item and builds over time so eventually the label is permanently coupled to the item;
b. wherein:
i. the item can be damaged as a result of the label being removed from the item after the label is permanently coupled to the items and
ii. if the label is applied to the item in a first position, then the adhesive is configured to allow a removal of the label from the item without damaging the item and a reapplication of the label to the item in a second position within a limited period of time.

2. The label according to claim 1, wherein the limited period of time is less than or equal to approximately five minutes.

3. The label according to claim 1, wherein the limited period of time is less than or equal to approximately one minute.

4. The label according to claim 1, wherein the adhesive is AT-1.

5. The label according to claim 1, wherein the adhesive is configured into a layer of adhesive.

6. The label according to claim 5, wherein the layer of adhesive has a thickness from approximately 10.2 micrometers to approximately 15.2 micrometers.

7. The label according to claim 5, wherein the layer of adhesive has a coat weight from approximately 13 grams per square meter to approximately 19 grams per square meter.

8. The label according to claim 5, wherein the layer of adhesive has a coat weight from approximately 15 grams per square meter to approximately 17 grams per square meter.

9. The label according to claim 1, further comprising a layer of face stock that is coupled to the layer of adhesive.

10. The label according to claim 9, wherein the label is configured so information can be printed on the layer of face stock using a printer selected from the group consisting of a laser printer, an inkjet printer, and a networked photocopier.

11. The label according to claim 9, wherein:
a. the label is configured to be coupled to a liner before the label is applied to the item; and
b. when the label is coupled to the liner, a layer of release agent is coupled between the adhesive and the liner.

12. The label according to claim 1, wherein the item is selected from the group consisting of an envelope, a postcard, a business card, a mailing tube, a piece of cardboard, a piece of paper, a box, a file folder, a binder, a notebook cover, a container, and a piece of foam display board.

13. A label that is configured to be applied to an items the label comprising:
a. an adhesive;
b. wherein:
i. the adhesive is configured to do the following if the label is applied to the item:
A. to allow a removal of the label from the item within a period of time, and
B. to eventually couple the label permanently to the items and
ii. the item can be damaged as a result of the label being removed from the item after the label is permanently coupled to the item.

14. The label according to claim 13, wherein the period of time is less than or equal to approximately five minutes.

15. The label according to claim 13, wherein the adhesive is configured to permanently couple the label to the item within 20 minutes after the label is applied to the item.

16. The label according to claim 13, wherein the adhesive is AT-1.

17. The label according to claim 13, wherein the adhesive is configured to allow for the removal of the label from the item within the period of time without damaging the label or the item.

18. A method for manufacturing a label that is configured to be applied to an items the method comprising:
a. providing a layer of face stock having a surface;
b. providing an adhesive; and
c. coupling the adhesive to the surface of the layer of face stock;
d. wherein:
i. the adhesive is configured to do the following after the label is applied to the item:
A. to allow for a removal of the label from the item within a period of time, and
B. to eventually couple the label permanently to the items and
ii. the item can be damaged as a result of the label being removed from the item after the label is permanently coupled to the item.

19. The method according to claim 18, wherein the step of coupling the adhesive to the surface of the face stock includes coating the adhesive on the surface of the layer of face stock.

20. The method according to claim 18, wherein the step of coupling the adhesive to the layer of face stock includes forming the adhesive into a layer of adhesive.

21. The method according to claim 18, wherein the period of time is less than or equal to approximately five minutes.

22. The method according to claim 18, wherein the adhesive is AT-1.
